(19) United States
(12) Patent Application Publication
(10) Pub. No.: US 2023/0309168 A1
(43) Pub. Date: Sep. 28, 2023

(54) MECHANISMS TO ENHANCE WIRELESS TSN CONFIGURATION TO SUPPORT PEER-TO-PEER COMMUNICATIONS

(71) Applicants: Dibakar Das, 18203807, OR (US); Dave A. Cavalcanti, Portland, OR (US); Javier Perez-Ramirez, North Plains, OR (US)

(72) Inventors: Dibakar Das, 18203807, OR (US); Dave A. Cavalcanti, Portland, OR (US); Javier Perez-Ramirez, North Plains, OR (US)

(21) Appl. No.: 18/203,807

(22) Filed: May 31, 2023

(51) Int. Cl. H04W 76/15; H04W 76/14

(52) U.S. Cl. CPC H04W 76/15; H04W 76/14

(57) ABSTRACT

An apparatus of a station (STA) includes memory and processing circuitry coupled to the memory. The processing circuitry is to detect a first peer-to-peer (p2p) wireless communication link of the STA is active within a wireless TSN network. A wireless link information element corresponding to the first p2p wireless communication link is encoded for transmission to an AP. The wireless link information element includes at least one attribute of the first p2p wireless communication link. A gate control list (GCL) received from the AP is decoded. The GCL originates from a central network controller (CNC) of the wireless TSN network, and the GCL is based on the at least one attribute in the wireless link information element. Transmission and reception schedules of the first p2p wireless communication link are configured based on the GCL.

### TECHNICAL FIELD

Embodiments pertain to wireless networks and wireless communications. Some embodiments relate to wireless local area networks (WLANs) and Wi-Fi networks including networks operating under the IEEE 802.11 family of standards. Some embodiments relate to mechanisms to enhance wireless time-sensitive networking (TSN) configuration to support peer-to-peer (p2p) communications.

### BACKGROUND

Many distributed time-sensitive applications (e.g. robotics, industry automation, and extended/virtual/augmented reality) have strict and low latency requirements for compute and networking tasks. Transmitting data with low latency and jitter is important for such applications. Time-sensitive networking (TSN) standards and solutions for wired (e.g., Ethernet) and wireless (e.g., Wi-Fi and 5G) networks haven been developed as means to ensure deterministic connectivity services that implement low latency and jitter. However, configuring communication between different nodes in such networks can be challenging.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram of a radio architecture in accordance with some embodiments;

FIG. 2 illustrates front-end module (FEM) circuitry in accordance with some embodiments;

FIG. 3 illustrates radio integrated circuit (IC) circuitry in accordance with some embodiments;

FIG. 4 illustrates a functional block diagram of baseband processing circuitry in accordance with some embodiments;

FIG. 5 illustrates a WLAN in accordance with some embodiments;

FIG. 6 is a network diagram illustrating an example network environment for time-sensitive networking (TSN), in accordance with some embodiments;

FIG. 7 is a diagram of a TSN reference stack that can be used in connection with disclosed techniques, in accordance with some embodiments;

FIG. 8 is a diagram of a wired-wireless TSN architecture, in accordance with some embodiments;

FIG. 9 is a diagram of a wired-wireless TSN architecture with p2p links in the wireless TSN domain, in accordance with some embodiments;

FIG. 10 is a swimlane diagram of an abstracted capability exchange between a talker station (STA) associated with an access point (AP) to a centralized user configuration (CUC) node coupled to a central network controller (CNC), in accordance with some embodiments;

FIG. 11 is a swimlane diagram of an abstracted capability exchange between a talker STA to the CUC where the STA is associated with a mobile AP while the device containing the mobile AP has an interface that is associated with an infrastructure AP, in accordance with some embodiments;

FIG. 12 illustrates example gate control list configurations that can be used by the infrastructure AP to configure the 802.11 Qbv schedule at each of its interfaces after receiving the CNC bridge configuration for the virtual interface for the example in FIG. 11, in accordance with some embodiments;

FIG. 13 is a flow diagram of an example method for enhancing wireless TSN configuration to support p2p communications, in accordance with some embodiments;

FIG. 14 illustrates a block diagram of an example machine upon which any one or more of the techniques (e.g., methodologies) discussed herein may perform; and

FIG. 15 illustrates a block diagram of an example wireless device upon which any one or more of the techniques (e.g., methodologies or operations) discussed herein may perform.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments outlined in the claims encompass all available equivalents of those claims.

Some embodiments relate to methods, computer-readable media, and apparatus for processing an EHT Physical Layer Convergence Procedure (PLCP) Protocol Data Unit (PPDU) with additional packet extension. In some embodiments, a physical layer (PHY) packet extension (PE) may be used to meet the trigger frame (TF) media access control (MAC) padding duration indicated by the MinTrigProcTime indicator, which is the time claimed by a client station (STA) to process the TF. However, due to the maximum 16 us duration for the PE field defined in the 802.11ax specification, the duration of the PE field may not be sufficient to meet the requirement of the MinTrigProcTime indicator. The disclosed techniques provide an extension of the PE field (e.g., by using a dummy orthogonal frequency division multiplexing (OFDM) symbol after the data portion of the EHT PPDU) so that the STA can meet the PHY and MAC processing time requirements. Additionally, the access point (AP) can indicate the presence of the PE extension (namely, the presence of the dummy OFDM symbol) using at least one of the fields of the EHT PPDU (e.g., a signal field such as the U-SIG field is used to indicate the presence of the dummy OFDM symbol).

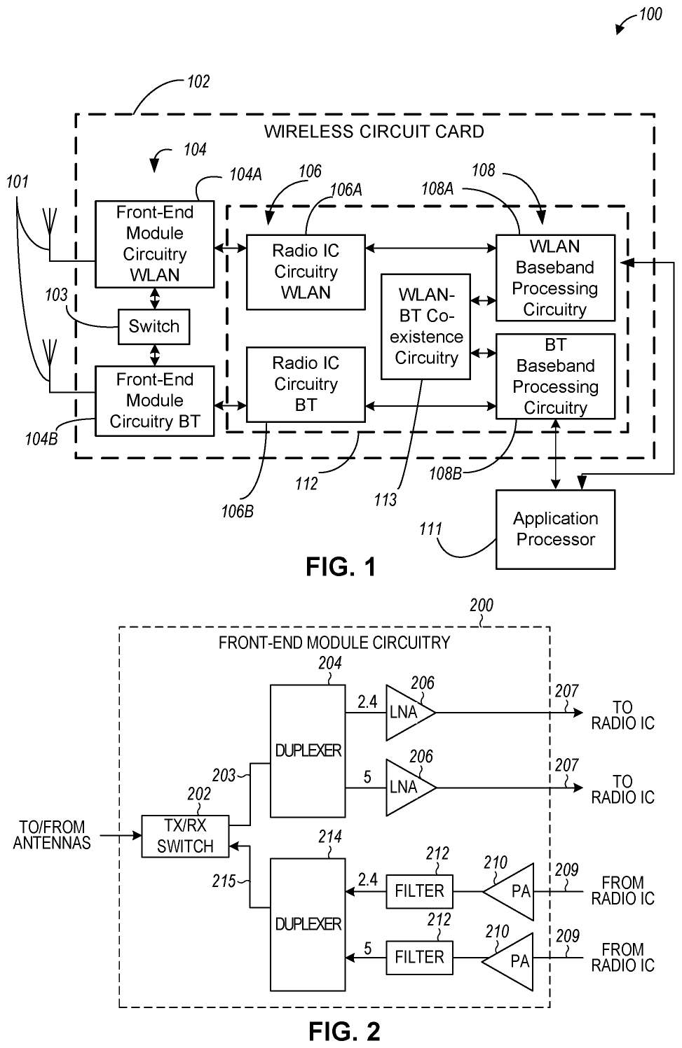

FIG. 1 is a block diagram of a radio architecture 100 in accordance with some embodiments. Radio architecture 100 may include radio front-end module (FEM) circuitry 104, radio IC circuitry 106, and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN (or Wi-Fi) FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals, and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals, and to provide the amplified versions of the received signals to the BT radio IC circuitry 106B for further processing. WLAN FEM circuitry 104A may also include a transmit signal path which may include circuitry configured to amplify WLAN signals provided by the WLAN radio IC circuitry 106A for wireless transmission by the one or more antennas 101. In addition, BT FEM circuitry 104B may also include a transmit signal path which may include circuitry configured to amplify BT signals provided by the radio IC circuitry 106B for wireless transmission by one or more antennas. In the embodiment of FIG. 1, although WLAN FEM circuitry 104A and BT FEM circuitry 104B are shown as being distinct from one another, embodiments are not so limited and include within their scope the use of a FEM (not shown) that includes a transmit path and/or a receive path for both WLAN and BT signals or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the WLAN FEM circuitry 104A and provide baseband signals to WLAN baseband processing circuitry 108A. BT radio IC circuitry 106B may, in turn, include a receive signal path which may include circuitry to down-convert BT RF signals received from the BT FEM circuitry 104B and provide baseband signals to BT baseband processing circuitry 108B. The WLAN radio IC circuitry 106A may also include a transmit signal path which may include circuitry to up-convert WLAN baseband signals provided by the WLAN baseband processing circuitry 108A and provide WLAN RF output signals to the WLAN FEM circuitry 104A for subsequent wireless transmission by one or more antennas 101. BT radio IC circuitry 106B may also include a transmit signal path which may include circuitry to up-convert BT baseband signals provided by the BT baseband processing circuitry 108B and provide BT RF output signals to the BT FEM circuitry 104B for subsequent wireless transmission by the one or more antennas 101. In the embodiment of FIG. 1, although radio IC circuitries 106A and 106B are shown as being distinct from one another, embodiments are not so limited and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband processing circuitry 108A and the BT baseband processing circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include a physical layer (PHY) and medium access control layer (MAC) circuitry, and may further interface with the application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband processing circuitry 108A and the BT baseband processing circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the one or more antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of the WLAN FEM circuitry 104A or the BT FEM circuitry 104B.

In some embodiments, the FEM circuitry 104, the radio IC circuitry 106, and baseband processing circuitry 108 may be provided on a single radio card, such as wireless radio card 102. In some other embodiments, one or more antennas 101, the FEM circuitry 104 and the radio IC circuitry 106 may be provided on a single radio card. In some other embodiments, the radio IC circuitry 106 and the baseband processing circuitry 108 may be provided on a single chip or IC, such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be a part of a Wi-Fi communication station (STA) such as a wireless access point (AP), a base station, or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, and/or IEEE 802.11ax standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax and 802.11be standards. In these embodiments, the radio architecture 100 may be configured to communicate in accordance with an OFDMA technique, although the scope of the embodiments is not limited in this respect.

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband processing circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection-oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as the wireless radio card 102, although embodiments are not so limited, and include within their scope discrete WLAN and BT radio cards

In some embodiments, the radio architecture 100 may include other radio cards, such as a cellular radio card configured for cellular (e.g., 3GPP such as LTE, LTE-Advanced, or 5G communications).

In some IEEE 802.11 embodiments, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. However, the scope of the embodiments is not limited concerning the above center frequencies.

FIG. 2 illustrates FEM circuitry 200 in accordance with some embodiments. The FEM circuitry 200 is one example of circuitry that may be suitable for use as the WLAN FEM circuitry 104A and/or the BT FEM circuitry 104B (of FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the FEM circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by the one or more antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and one or more filters 212, such as a BPF, an LPF, or another type of filter for each frequency spectrum and a transmit signal path duplexer 214 to provide the signals of one of the different spectrums onto a single transmit path for subsequent transmission by the one or more antennas 101 (FIG. 1). In some embodiments, BT communications may utilize the 2.4 GHz signal paths and may utilize the same FEM circuitry 200 as the one used for WLAN communications.

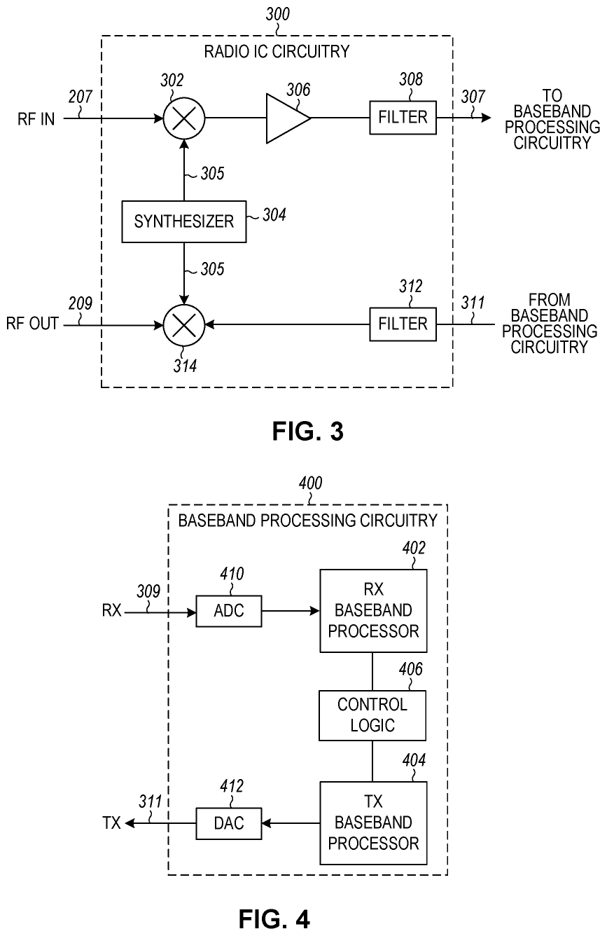

FIG. 3 illustrates radio integrated circuit (IC) circuitry 300 in accordance with some embodiments. The radio IC circuitry 300 is one example of circuitry that may be suitable for use as the WLAN radio IC circuitry 106A or the BT radio IC circuitry 106B (of FIG. 1), although other circuitry configurations may also be suitable.

In some embodiments, the radio IC circuitry 300 may include a receive signal path and a transmit signal path. The receive signal path of the radio IC circuitry 300 may include mixer circuitry 302, such as, for example, down-conversion mixer circuitry, amplifier circuitry 306, and filter circuitry 308. The transmit signal path of the radio IC circuitry 300 may include filter circuitry 312 and mixer circuitry 314, such as up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry and may include, although not shown, embodiments where each of the depicted circuitries may include more than one component. For instance, mixer circuitry 302 and/or 314 may each include one or more mixers, and filter circuitry 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the frequency 305 provided by synthesizer circuitry 304. The amplifier circuitry 306 may be configured to amplify the down-converted signals and the filter circuitry 308 may include an LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert baseband signals 311 based on the frequency 305 provided by the synthesizer circuitry 304 to generate RF signals 209 for the FEM circuitry 104. The baseband signals 311 may be provided by the baseband processing circuitry 108 and may be filtered by filter circuitry 312. The filter circuitry 312 may include an LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature-phase (Q) paths). In such an embodiment, RF signals 207 from FIG. 3 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as frequency 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in the duty cycle (the percentage of one period in which the LO signal is high) and/or offset (the difference between the start points of the period). In some embodiments, the LO signals may have a 25% duty cycle and a 50% offset. In some embodiments, each branch of the mixer circuitry (e.g., the in-phase (I) and quadrature-phase (Q) path) may operate at a 25% duty cycle, which may result in a significant reduction in power consumption.

The RF signals 207 (FIG. 2) may comprise a balanced signal, although the scope of the embodiments is not limited in this respect. The I and Q baseband output signals may be provided to the low-noise amplifier, such as amplifier circuitry 306 (FIG. 3) or filter circuitry 308 (FIG. 3).

In some embodiments, the output baseband signals 307 and the baseband signals 311 may be analog, although the scope of the embodiments is not limited in this respect. In some alternate embodiments, the output baseband signals 307 and the baseband signals 311 may be digital. In these alternate embodiments, the radio IC circuitry may include an analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage-controlled oscillator (VCO), although that is not a requirement. A divider control input may further be provided by either the baseband processing circuitry 108 (FIG. 1) or the application processor 111 (FIG. 1) depending on the desired output frequency. In some embodiments, a divider control input (e.g., N) may be determined from a look-up table (e.g., within a Wi-Fi card) based on a channel number and a channel center frequency as determined or indicated by the application processor 111.

In some embodiments, synthesizer circuitry 304 may be configured to generate a carrier frequency as frequency 305, while in other embodiments, frequency 305 may be a fraction of the carrier frequency (e.g., one-half the carrier frequency, one-third the carrier frequency). In some embodiments, frequency 305 may be a LO frequency (fLO).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor 402 for processing receive baseband signals 309 provided by the radio IC circuitry 106 (FIG. 1) and a transmit baseband processor 404 for generating baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the receive baseband processor 402. In these embodiments, the baseband processing circuitry 400 may also include DAC 412 to convert digital baseband signals from the transmit baseband processor 404 to analog baseband signals.

In some embodiments that communicate OFDM signals or OFDMA signals, such as through the WLAN baseband processing circuitry 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring to FIG. 1, in some embodiments, the one or more antennas 101 (FIG. 1) may each comprise one or more directional or omnidirectional antennas, including, for example, dipole antennas, monopole antennas, patch antennas, loop antennas, microstrip antennas, or other types of antennas suitable for transmission of RF signals. In some multiple-input multiple-output (MIMO) embodiments, the antennas may be effectively separated to take advantage of spatial diversity and the different channel characteristics that may result. The one or more antennas 101 may each include a set of phased-array antennas, although embodiments are not so limited.

Although the radio architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application-specific integrated circuits (ASICs), radio-frequency integrated circuits (RFICs), and combinations of various hardware and logic circuitry for performing at least the functions described herein. In some embodiments, the functional elements may refer to one or more processes operating on one or more processing elements.

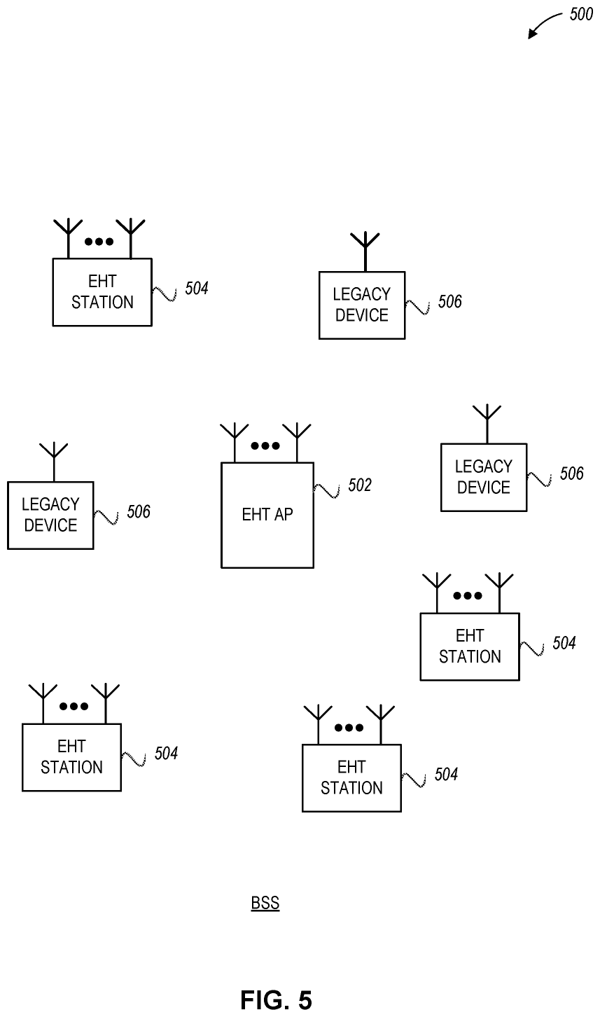

FIG. 5 illustrates a WLAN 500 in accordance with some embodiments. The WLAN 500 may comprise a basis service set (BSS) that may include a HE access point (AP) 502, which may be termed an AP, a plurality of extremely high throughput (EHT) (e.g., IEEE 802.11ax/be) stations (STAs) 504, and legacy devices 506 (e.g., IEEE 802.11g/n/ac devices). In some aspects, AP 502 is an EHT AP. In some embodiments, the EHT STAs 504 and/or AP 502 are configured to operate in accordance with IEEE 802.11 EHT. In some embodiments, the EHT STAs 504 and/or AP 502 are configured to operate in accordance with IEEE 802.11az. In some embodiments, IEEE 802.11EHT may be termed Next Generation 802.11. In some embodiments, the AP 502 may be configured to operate a HE BSS, ER BSS, and/or a BSS. Legacy devices may not be able to operate in the HE BSS and beacon frames in the HE BSS may be transmitted using HE PPDUs. An ER BSS may use ER PPDUs to transmit the beacon frames and legacy devices 506 may not be able to decode the beacon frames and thus are not able to operate in an ER BSS. The BSSs, e.g., BSS, ER BSS, and HE BSS may use different BSSIDs.

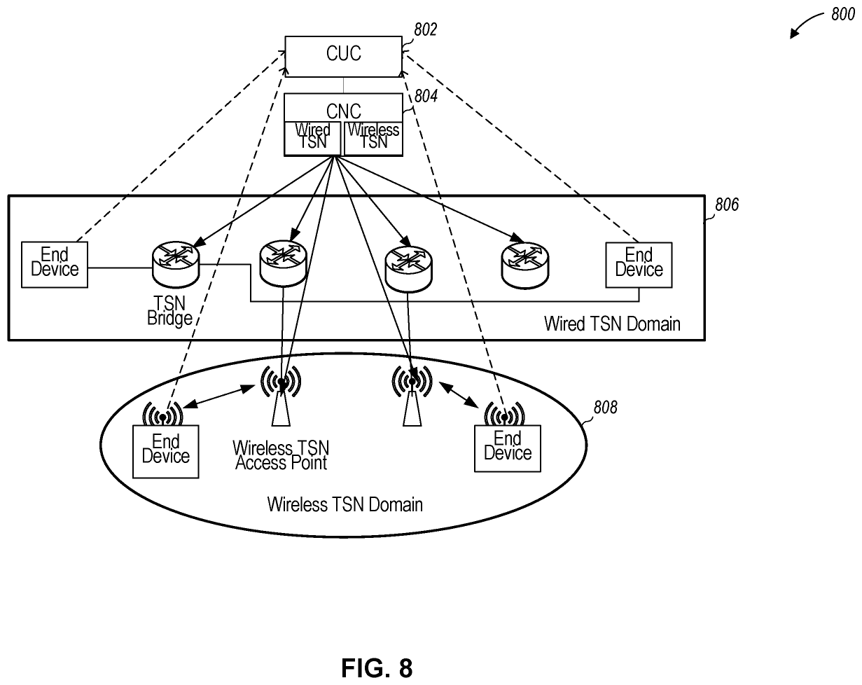

The AP 502 may be an AP using IEEE 802.11 to transmit and receive. The AP 502 may be a base station. The AP 502 may use other communications protocols as well as the IEEE 802.11 protocol. The IEEE 802.11 protocol may be IEEE 802.11ax. The IEEE 802.11 protocol may be IEEE 802.11 next generation. The EHT protocol may be termed a different name in accordance with some embodiments. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one AP 502 that is part of an extended service set (ESS). A controller (not illustrated) may store information that is common to more than one HE APs and may control more than one BSS, e.g., assign primary channels, colors, etc. AP 502 may be connected to the Internet. The AP 502 and/or EHT STA 504 may be configured for one or more of the following: 320 MHz bandwidth, 16 spatial streams, multi-band or multi-stream operation, and 4096 QAM. Additionally, the AP 502 and/or EHT STA 504 may be configured for generating and processing EHT PPDUs that include an extension of the PE field (e.g., a dummy OFDM symbol) (e.g., as disclosed in conjunction with FIG. 8-FIG. 11) to meet both PHY and MAC processing time requirements.

The legacy devices 506 may operate in accordance with one or more of IEEE 802.11 a/b/g/n/ac/ad/af/ah/aj/ay, or another legacy wireless communication standard. The legacy devices 506 may be STAs or IEEE STAs. In some embodiments, when the AP 502 and EHT STAs 504 are configured to operate in accordance with IEEE 802.11EHT, the legacy devices 506 may include devices that are configured to operate in accordance with IEEE 802.11ax. The EHT STAs 504 may be wireless transmit and receive devices such as cellular telephones, portable electronic wireless communication devices, smart telephones, handheld wireless devices, wireless glasses, wireless watches, wireless personal devices, tablets, or another device that may be transmitting and receiving using the IEEE 802.11 protocol such as IEEE 802.11EHT or another wireless protocol. In some embodiments, the EHT STAs 504 may be termed extremely high throughput (EHT) stations or stations.

The AP 502 may communicate with legacy devices 506 in accordance with legacy IEEE 802.11 communication techniques. In example embodiments, the AP 502 may also be configured to communicate with EHT STAs 504 in accordance with legacy IEEE 802.11 communication techniques.

In some embodiments, a HE or EHT frame may be configurable to have the same bandwidth as a channel. The HE or EHT frame may be a Physical Layer Convergence Procedure (PLCP) Protocol Data Unit (PPDU). In some embodiments, there may be different types of PPDUs that may have different fields and different physical layers, and/or different media access control (MAC) layers. For example, a single-user (SU) PPDU, multiple-user (MU) PPDU, extended-range (ER) SU PPDU, and/or trigger-based (TB) PPDU. In some embodiments, EHT may be the same or similar to HE PPDUs.

The bandwidth of a channel may be 20 MHz, 40 MHz, or 80 MHz, 80+80 MHz, 160 MHz, 160+160 MHz, 320 MHz, 320+320 MHz, and 640 MHz bandwidths. In some embodiments, the bandwidth of a channel less than 20 MHz may be 1 MHz, 1.25 MHz, 2.03 MHz, 2.5 MHz, 4.06 MHz, 5 MHz, and 10 MHz, or a combination thereof or another bandwidth that is less or equal to the available bandwidth may also be used. In some embodiments, the bandwidth of the channels may be based on several active data subcarriers. In some embodiments, the bandwidth of the channels is based on 26, 52, 106, 242, 484, 996, or 2×996 active data subcarriers or tones that are spaced by 20 MHz. In some embodiments, the bandwidth of the channels is 256 tones spaced by 20 MHz. In some embodiments, the channels are multiple of 26 tones or a multiple of 20 MHz. In some embodiments, a 20 MHz channel may comprise 242 active data subcarriers or tones, which may determine the size of a Fast Fourier Transform (FFT). An allocation of bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz, and 80+80 MHz OFDMA HE PPDU formats. In some embodiments, the 106-subcarrier RU is used in the 20 MHz, 40 MHz, 80 MHz, 160 MHz, and 80+80 MHz OFDMA and MU-MIMO HE PPDU formats. In some embodiments, the 242-subcarrier RU is used in the 40 MHz, 80 MHz, 160 MHz, and 80+80 MHz OFDMA and MU-MIMO HE PPDU formats. In some embodiments, the 484-subcarrier RU is used in the 80 MHz, 160 MHz, and 80+80 MHz OFDMA and MU-MIMO HE PPDU formats. In some embodiments, the 996-subcarrier RU is used in the 160 MHz and 80+80 MHz OFDMA and MU-MIMO HE PPDU formats.

A HE or EHT frame may be configured for transmitting several spatial streams, which may be in accordance with MU-MIMO and may be in accordance with OFDMA. In other embodiments, the AP 502, the EHT STAB 504, and/or the legacy devices 506 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), Bluetooth®, low-power Bluetooth®, or other technologies.

In accordance with some IEEE 802.11 embodiments, e.g., IEEE 802.11EHT/ax embodiments, an AP 502 may operate as a master station which may be arranged to contend for a wireless medium (e.g., during a contention period) to receive exclusive control of the medium for a transmission opportunity (TXOP). The AP 502 may transmit an EHT/HE trigger frame transmission, which may include a schedule for simultaneous UL transmissions from EHT STAs 504. The AP 502 may transmit a time duration of the TXOP and sub-channel information. During the TXOP, EHT STAs 504 may communicate with the AP 502 in accordance with a non-contention-based multiple access technique such as OFDMA or MU-MIMO. This is unlike conventional WLAN communications in which devices communicate in accordance with a contention-based communication technique, rather than multiple access techniques. During the HE or EHT control period, the AP 502 may communicate with EHT STAs 504 using one or more HE or EHT frames. During the TXOP, the EHT STAs 504 may operate on a sub-channel smaller than the operating range of the AP 502. During the TXOP, legacy stations refrain from communicating. The legacy stations may need to receive the communication from the AP 502 to defer from communicating.

In accordance with some embodiments, during the TXOP the EHT STAs 504 may contend for the wireless medium with the legacy devices 506 being excluded from contending for the wireless medium during the master-sync transmission. In some embodiments, the trigger frame may indicate a UL-MU-MIMO and/or UL OFDMA TXOP. In some embodiments, the trigger frame may include a DL UL-MU-MIMO and/or DL OFDMA with a schedule indicated in a preamble portion of the trigger frame.

In some embodiments, the multiple-access technique used during the HE or EHT TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy devices 506 and/or EHT STAs 504 in accordance with legacy IEEE 802.11 communication techniques. In some embodiments, the AP 502 may also be configurable to communicate with EHT STAs 504 outside the HE TXOP in accordance with legacy IEEE 802.11 or IEEE 802.11EHT/ax communication techniques, although this is not a requirement.

In some embodiments, the EHT STA 504 may be a “group owner” (GO) for peer-to-peer modes of operation. A wireless device may be a HE station or an AP 502. In some embodiments, the EHT STA 504 and/or AP 502 may be configured to operate in accordance with IEEE 802.11mc. In example embodiments, the radio architecture of FIG. 1 is configured to implement the EHT STA 504 and/or the AP 502. In example embodiments, the front-end module circuitry of FIG. 2 is configured to implement the EHT STA 504 and/or the AP 502. In example embodiments, the radio IC circuitry of FIG. 3 is configured to implement the EHT STA 504 and/or the AP 502. In example embodiments, the base-band processing circuitry of FIG. 4 is configured to implement the EHT STA 504 and/or the AP 502.

In example embodiments, the EHT STAs 504, AP 502, an apparatus of the EHT STAs 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein described in conjunction with FIGS. 1-15 or may be implemented as part of devices that perform such methods and operations/functions.

In example embodiments, the EHT STA 504 and/or the AP 502 are configured to perform the methods and operations/functions described herein in conjunction with FIGS. 1-15. In example embodiments, an apparatus of the EHT STA 504 and/or an apparatus of the AP 502 are configured to perform the methods and functions described herein in conjunction with FIGS. 1-15. The term Wi-Fi may refer to one or more of the IEEE 802.11 communication standards. AP and STA may refer to AP 502 and/or EHT STA 504 (or an HE STA) as well as legacy devices 506.

In some embodiments, a HE AP STA may refer to an AP 502 and/or an EHT STAs 504 that is operating as a HE AP. In some embodiments, when an EHT STA 504 is not operating as a HE AP, it may be referred to as a HE non-AP STA or HE non-AP. In some embodiments, EHT STA 504 may be referred to as either a HE AP STA or a HE non-AP. EHT may refer to a next-generation IEEE 802.11 communication protocol, which may be IEEE 802.11be or may be designated another name.

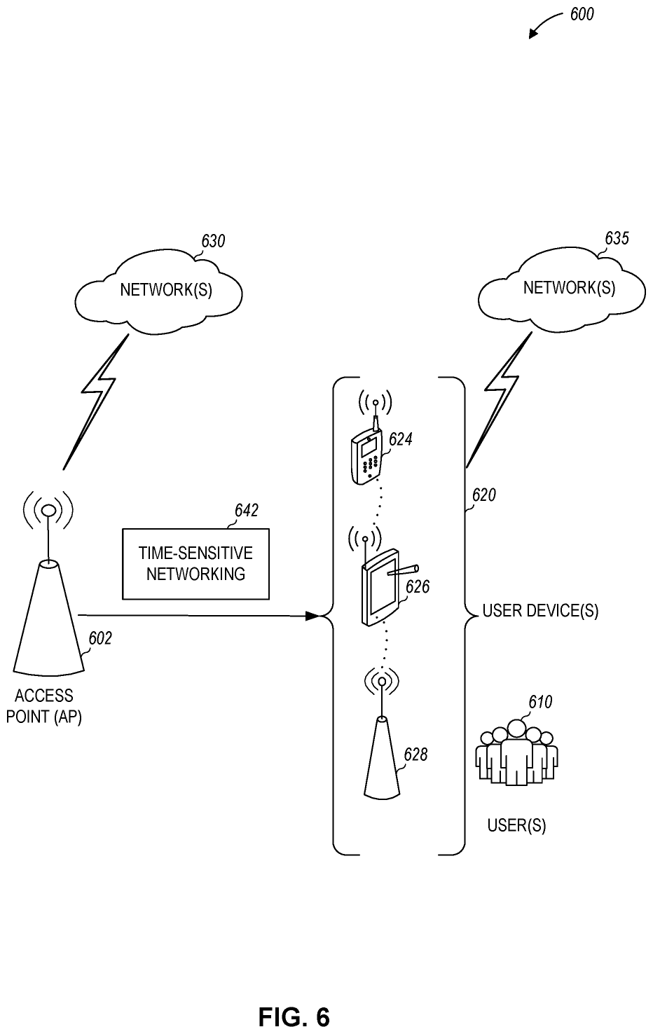

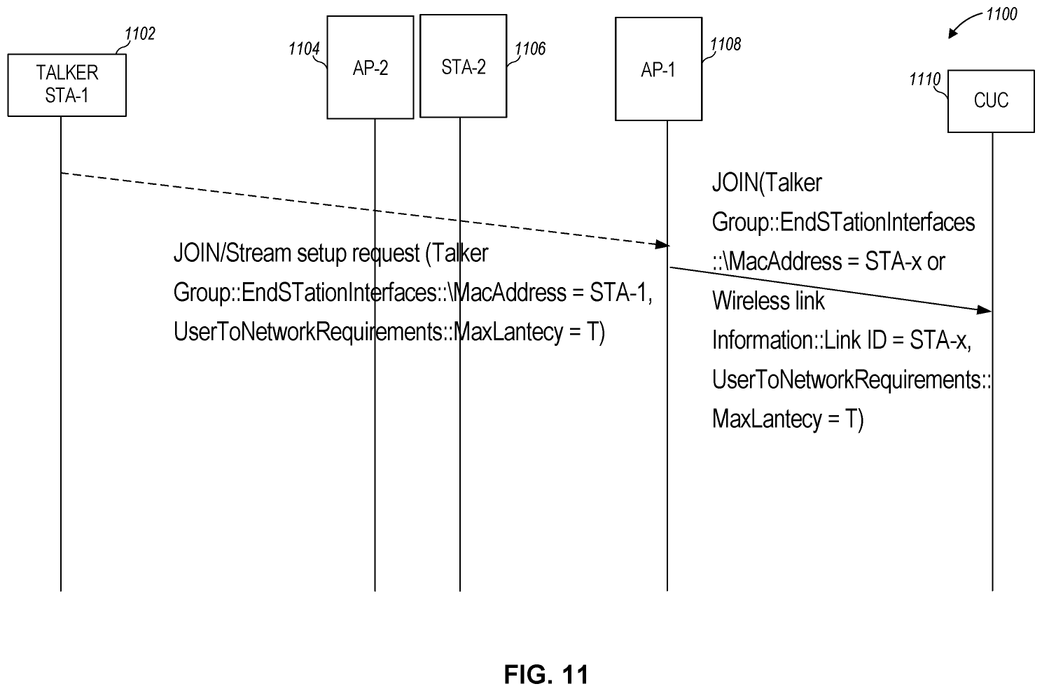

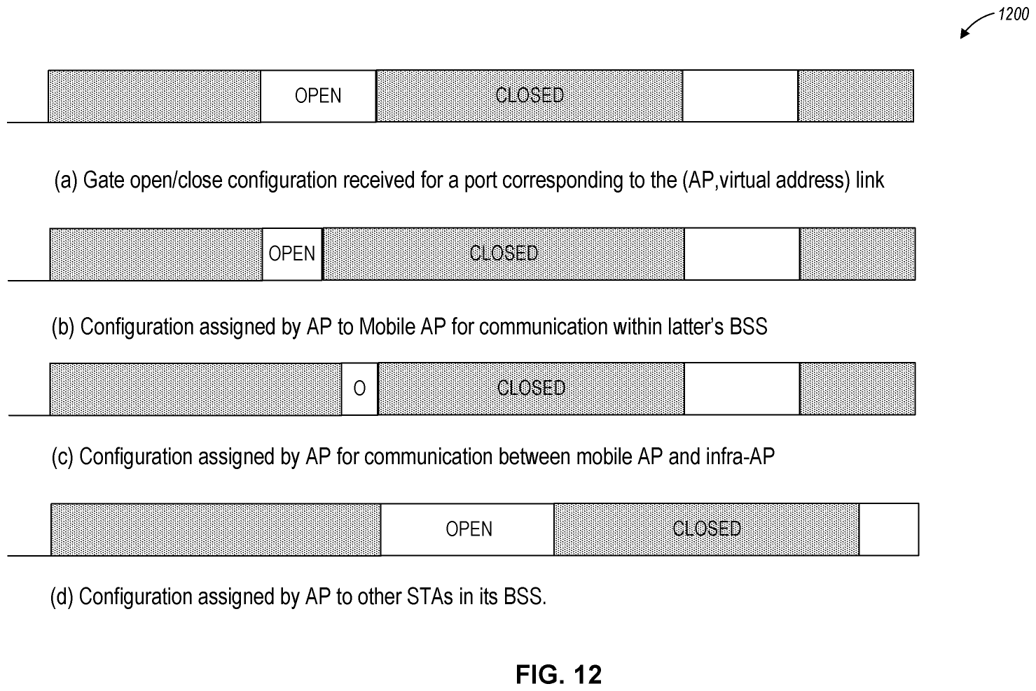

FIG. 6 is a network diagram illustrating an example network environment for time-sensitive networking (TSN), in accordance with some embodiments. Wireless network 600 may include one or more user devices 620 and at least one access point (AP) 602, which may communicate in accordance with IEEE 802.11 communication standards. The one or more user devices 620 may be mobile devices that are non-stationary (e.g., not having fixed locations) or may be stationary devices. In some embodiments, the one or more user devices 620 and the at least one AP 602 may include one or more computer systems similar to that of the functional diagram of FIG. 11 or FIG. 12.

The one or more user devices 620 and/or at least one AP 602 may be operable by one or more users 610. It should be noted that any addressable unit may be a station (STA). An STA may take on multiple distinct characteristics, each of which shapes its function. For example, a single addressable unit might simultaneously be a portable STA, a quality-of-service (QoS) STA, a dependent STA, and a hidden STA. The one or more user devices 620 and the at least one AP 602 may be STAs. The one or more user devices 620 and/or the at least one AP 602 may operate as a personal basic service set (PBSS) control point/access point (PCP/AP). The one or more user devices 620 (e.g., user device 624, user device 626, or user device 628) and/or the at least one AP 602 may include any suitable processor-driven device including, but not limited to, a mobile device or a non-mobile, e.g., a static device. For example, the one or more user devices 620 and/or the at least one AP 602 may include, user equipment (UE), an STA, an AP, or another device. The one or more user device 620 and/or the at least one AP 602 may also include mesh stations in, for example, a mesh network, in accordance with one or more IEEE 802.11 standards and/or 3GPP standards.

Any of the one or more user devices 620 (e.g., user devices 624-628) and the at least one AP 602 may be configured to communicate with each other via one or more communications networks 630 and/or 635, which can be wireless or wired networks. The one or more user devices 620 may also communicate peer-to-peer or directly with each other with or without the at least one AP 602. Any of the one or more communications networks 630 and/or 635 may include but is not limited to, any one of a combination of different types of suitable communications networks such as broadcasting networks, cable networks, public networks (e.g., the Internet), private networks, wireless networks, cellular networks, or any other suitable private and/or public networks.

Any of the one or more user devices 620 (e.g., user devices 624-628) and the at least one AP 602 may include one or more communications antennas. The one or more communications antennas may be any suitable type of antenna corresponding to the communications protocols used by the one or more user devices 620 (e.g., user devices 624-628), and the at least one AP 602. Some non-limiting examples of suitable communications antennas include Wi-Fi antennas, the Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the one or more user devices 620 and/or the at least one AP 602.

Any of the one or more user devices 620 (e.g., user devices 624-628) and the at least one AP 602 may be configured to perform directional transmission and/or directional reception in conjunction with wirelessly communicating in a wireless network. Any of the one or more user devices 620 (e.g., user devices 624-628) and the at least one AP 602 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the one or more user devices 620 (e.g., user devices 624-628), and the at least one AP 602 may be configured to perform any given directional transmission towards one or more defined transmit sectors. Any of the one or more user devices 620 (e.g., user devices 624-628) and the at least one AP 602 may be configured to perform any given directional reception from one or more defined receive sectors.

MIMO beamforming in a wireless network may be accomplished using RF beamforming and/or digital beamforming. In some embodiments, in performing a given MIMO transmission, any of the one or more user devices 620 (e.g., user devices 624-628) and the at least one AP 602 may be configured to use all or a subset of its one or more communications antennas to perform MIMO beamforming.

Any of the one or more user devices 620 (e.g., user devices 624-628) and the at least one AP 602 may include any suitable radio and/or transceiver for transmitting and/or receiving radio frequency (RF) signals in the bandwidth and/or channels corresponding to the communications protocols utilized by any of the one or more user devices 620 and the at least one AP 602 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHz channels (e.g. 802.11ad, 802.11ay). 700 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 702.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband. IEEE draft specification IEEE P802.11ax/D4.0, February 2019 is incorporated herein by reference in its entirety.

In one embodiment, and with reference to FIG. 6, the at least one AP 602 may facilitate time-sensitive networking 642 with the one or more user devices 620 using the disclosed techniques. It is understood that the above descriptions are for purposes of illustration and are not meant to be limiting.

Many distributed time-sensitive applications (e.g. robotics, industry automation, extended/virtual/augmented reality) have strict and low latency requirements for compute and networking tasks. Transmitting data with low latency and jitter is important. Time-sensitive networking (TSN) standards and solutions for wired (Ethernet) and wireless (Wi-Fi and 5G) networks haven been developed as means to ensure deterministic connectivity services that ensure low latency and jitter.

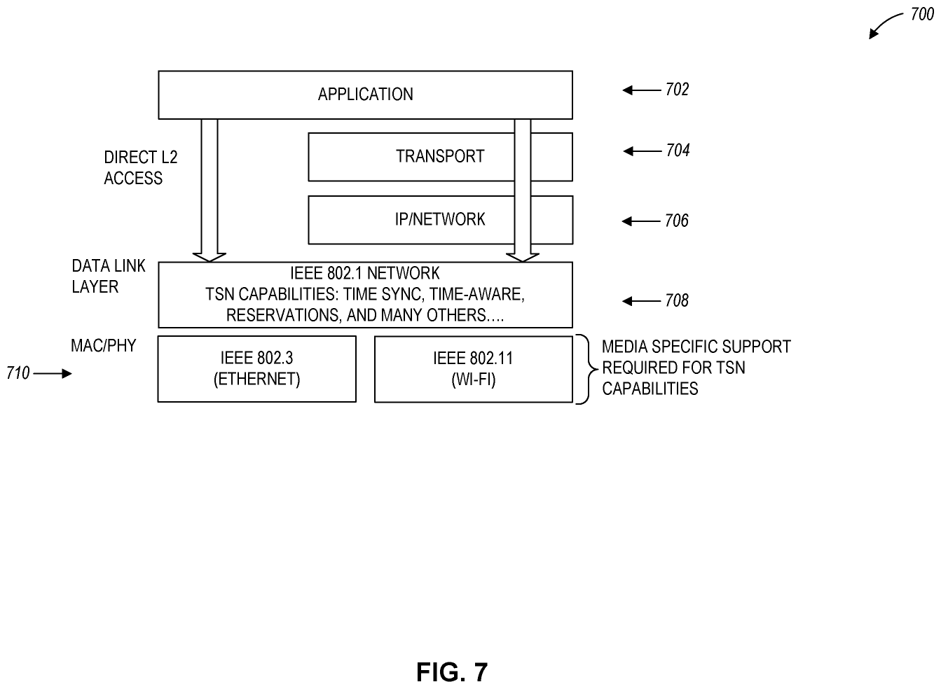

FIG. 7 is a diagram of a TSN reference stack 700 which can be used in connection with disclosed techniques, in accordance with some embodiments. Referring to FIG. 7, the TSN reference stack 700 includes an application layer 702, a transport layer 704, an Internet protocol (IP)/network layer 706, a data link layer 708, and media access control (MAC)/physical (PHY) layer 710. The application layer can be configured with direct layer 2 (L2) access to the data link layer 708.

In some embodiments, applications can be configured to indicate (or describe) the expected transmission time for its data in Ethernet network interface cards (NICs) supporting TSN features. In some aspects, applications can use sockets to send data across the network. During this process, the applications can set various options in the socket to indicate how the data in the packet needs to be treated by the lower layers in the networking stack. In some aspects, a TSN application uses the SO_TXTIME socket option to configure the transmission time for each frame. In some aspects, the application uses this method to indicate to the network adapter the expected transmission time of the time-critical packet. This information is used by the networking stack (e.g., the TSN reference stack 700) and TSN-capable Ethernet network adapters to schedule the packet for transmission. In some aspects, this metadata can be inserted or modified by an intermediate layer above the network stack to align transmission times to schedules. The Ethernet network adapter uses this information to prioritize and schedule time-sensitive packets to ensure timely delivery of the packets with very low jitter.

The IEEE 802.1 TSN standards comprise several mechanisms to achieve deterministic latency bounds with high reliability. Of them, the 802.1 Qbv protocol along with 802.1 Qcc allows a centralized entity to configure the traffic class queues at the egress ports to achieve time-aware prioritization of traffic flows.

FIG. 8 is a diagram of a wired-wireless TSN architecture 800, in accordance with some embodiments. More specifically, FIG. 8 illustrates a TSN architecture configured according to the 802.1Qcc specification. The wired-wireless TSN architecture 800 includes a centralized user configuration (CUC) node 802, a central network controller (CNC) 804, a wired TSN domain 806, and a wireless TSN domain 808. The communication within the wired-wireless TSN architecture 800 can be configured as follows:

(a) The CUC node 802 receives information about traffic stream characteristics from the talker and listener STAs and passes this information to CNC 804.

(b) The CNC 804 is responsible for configuring the end-to-end path for the stream from the talker to the listener via intermediate bridges. Essentially, the CNC 804 computes the scheduling needed at each intermediate bridge and end stations to satisfy the requirements for this stream. It does so by collecting bridge capability information.

Once the schedule is computed, the CNC 804 configures the transmission logic at each associated port before informing the CUC node 802. With 802.1 Qbv, the configuration step involves the CNC 804 distributing gate open/closed logic (“Gate Control List”) for the involved bridge ports. Specifically, each port contains multiple transmit queues each corresponding to a different traffic class. Each queue has a corresponding Transmission Gate s.t., the packets from a queue are only transmitted when the state of the corresponding Transmission Gate is “Open”.

(c) Depending on the network configuration, the CNC 804 may be implemented as a logical entity as part of a Wireless LAN Controller of part of the access points in the case of a wireless domain.

For a wireless TSN, it may be desirable to extend the Qbv functionality s.t. end-to-end QoS guarantees can be provided even when including Wi-Fi STAs as talker, listener, or bridges.

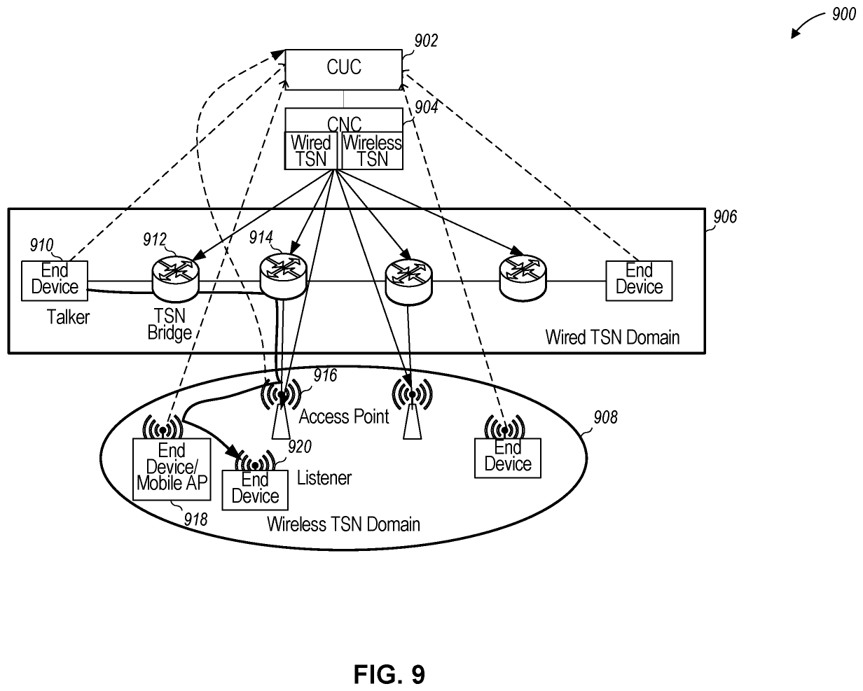

In some embodiments, to calculate the optimum schedule to serve the time-critical traffic streams, the CNC collects the interface capabilities at each involved port. In particular, the Bridge Delay attribute indicates the delay within the bridge as well as on the PHY interface per Port per Traffic class. In some aspects, the wireless link is always a link between STA and AP, referred to hereafter as the BSS link. However, there are emerging applications and use cases where two STAs may establish a peer-to-peer (p2p) link to exchange time-critical traffic within the BSS as shown in FIG. 9.

One example is offloading Augmented/Virtual Reality workloads from a Head Mounted Device (HMD) to a laptop. In this case, an STA may operate as Mobile AP (or Soft-AP) and communicate with another STA in the p2p link while communicating with the AP in the BSS link. The first inefficiency is that CNC must be aware of p2p links within the BSS that may interfere with BSS links. There is no signaling to differentiate a p2p link from a general BSS link when providing device configuration information related to TSN operation. A second inefficiency is that devices may have constraints when supporting multiple Wi-Fi interfaces, such as both BSS and p2p interfaces may not be simultaneously active due to self-interference issues in the platform. The p2p interface may add new constraints that need to be considered by the CNC and/or the AP when defining TSN scheduling configuration for time-sensitive flows that need to be delivered across both BSS and p2p links. As such the current signaling of the bridge capabilities is insufficient when accounting for a Wi-Fi device with multiple Wi-Fi interfaces that main operate in BSS and p2p modes. The above-listed inefficiencies can be addressed using the disclosed techniques.

The disclosed techniques include adding additional information to a managed object or attribute for a bridge port that corresponds to a Wi-Fi interface to enable the network configuration/management entities to identify p2p links and associated constraints when multiple interfaces are supported. In some aspects, the new configuration attributes enhance the management of p2p wireless links within a wired-wireless TSN system. The disclosed techniques can be based on the following functionalities:

(a) New attribute to describe multiple links including p2p links and any associated constraints between collocated links such as whether simultaneous transmission is allowed or not across the links.

(b) New methods to consider p2p links as part of the configuration of TSN schedules based on 802.1Qbv including explicit and implicit configuration options.

The disclosed techniques can be used to assist Wi-Fi networks to be better integrated with TSN applications and benefit from the deterministic latency guarantees provided by 802.1 Qbv by extending the operation to include both BSS and p2p links. The proposed techniques also apply to wireless-only networks where TSN features are managed by the AP or WLAN controller and used to prioritize latency-sensitive traffic. The proposed solution can avoid potential harmful interference when p2p links are used within a BSS when TSN features are deployed. Enabling to extend TSN operation to p2p links also creates more opportunities for leveraging client platforms for offloading time-critical workloads, such as the Extended Reality (XR) applications.

FIG. 9 is a diagram of a wired-wireless TSN architecture 900 with p2p links in the wireless TSN domain, in accordance with some embodiments. More specifically, the wired-wireless TSN architecture 900 includes a CUC node 902, a CNC 904, a wired TSN domain 906, and a wireless TSN domain 908. An example communication path between a talker device (e.g., end device 910) and a listener device (e.g., end device 920) includes TSN bridge 912, TSN bridge 914, AP 916, and end device (e.g., mobile AP) 918.

In some aspects, for a bridge port that corresponds to a wireless device (wireless port), the managed resource includes information about (a) multiple collocated wireless interfaces on the same devices; (b) the operation mode (e.g. BSS, p2p) and associated parameters in each interface (e.g. operating channel); and (c) operation constraints for collocated interfaces within the devices, such as interfaces that can't be activated simultaneously.

In some aspects, the disclosed techniques include two approaches for introducing p2p links to the overall TSN configuration signaling:
(a) Case 1—Explicit p2p link configuration: the talker, listener, and bridge interfaces within a BSS including the p2p link are known to the network configuration entities (CNC and/or AP).
(b) Case 2—Implicit p2p link configuration: information about STAs within the BSS and their p2p links is abstracted to the network configuration entities (CNC and/or AP).

For Case 1, In some aspects, the network configuration entities (CUC/CNC and/or AP) are aware of the p2p links, which can be enabled by introducing the following in the configuration attributes to the wireless interfaces:

(a) Multiple wireless link information elements where each element may contain the following attributes:
(a.1) Link ID: Address of the wireless interface (this may be the MAC address for the link);
(a.2) Link mode: BSS or p2p mode; and
(a.3) Channel number: operating channel number.
(b) Each link information element may also include other attributes such as:
(b.1) IndependentDelayMin/Max: Minimum and maximum delays as defined in 802.1Qcc;
(b.2) WirelessLinkDependDelay Descriptor: DelayCDF (e.g., an array of delays and percentile values), MeanDelay, DelayStdDevication, and DelayUpdatelnterval (e.g., a minimal interval for which the delay descriptor is valid. If not updated, the descriptor is valid for another interval).
(c) If multiple link information elements are included in the configuration information, the wireless interface configuration attribute shall also include the following attribute that describes operational constraints between links:
(c.1) link operation constraints list:
(c.1.1) No simultaneous operation list: includes a list of link IDs that cannot operate simultaneously. In one embodiment, the device may not be able to operate simultaneously in any link and a simpler signaling may be used.
(c.1.2) Simultaneous operation list: includes a list of link IDs that can operate simultaneously.

For Case 2, the disclosed techniques include a method in which p2p links are considered implicitly when reporting configuration information and allocating resources within the BSS to meet the requirements for time-critical flows that may traverse BSS and p2p links.

In some aspects, the disclosed techniques include the following:
(a) In one embodiment, an AP acts as a proxy for all streams originating or ending within its BSS and abstracts information identifying the individual STAs participating in that stream when reporting configuration information to the CNC. For example:
(a.1) When either the talker or listener is an STA within its BSS, the AP may create a dummy or virtual Wireless Link Information element corresponding to a “virtual interface” whose Link ID field includes a dummy or special MAC address or some other identifier instead of the talker or listener's MAC address.
(a.2) The AP may maintain multiple virtual interfaces each represented by a different Wireless link information element and corresponding to a group of STAs with similar link quality/data rates. Out of them, the AP picks the Wireless Link Information element to be the one for which the Wireless Link Dependent Delay information closely matches the actual Dependent Delay parameters.
(a.3) If a UserToNetworkRequirements group is included in a Join message, the MaxLatency field is set, after accounting for the wireless link, as the real MaxLatency for the end-to-end path−(latency for the (virtual interface, AP) link)+latency for the (talker/listener, AP) link. The latency for the (virtual interface, AP) link is the transmission time (plus potential contention delay) of the frame using the data rate known from the Wireless link Dependent Delay parameter for that virtual interface. The latency for the (talker/listener, AP) link is the transmission time (plus potential contention delay) of the frame using the data rate between the AP and that STA.

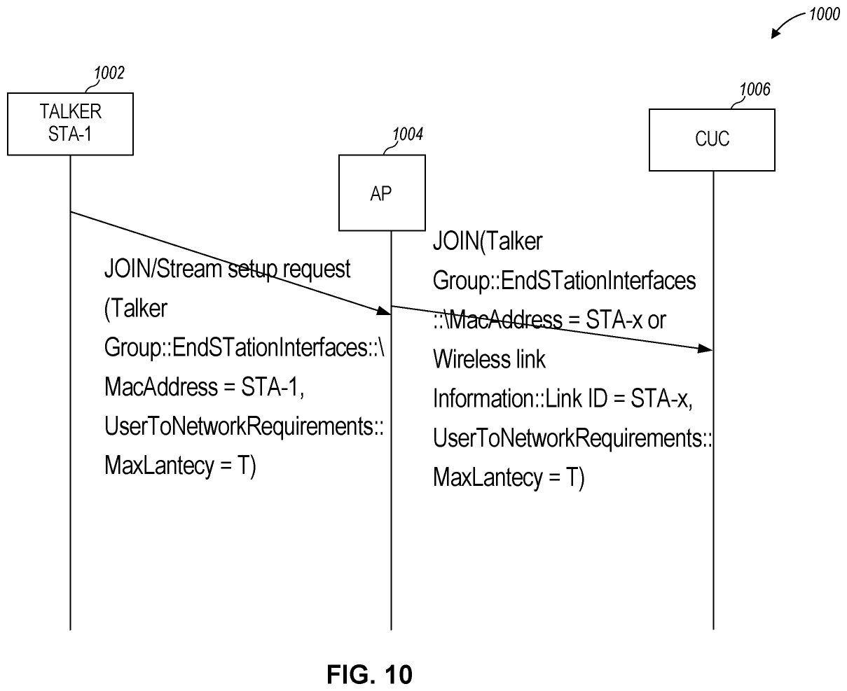

FIG. 10 is a swimlane diagram of an abstracted capability exchange 1000 between a talker station (STA) 1002 associated with an access point (AP) 1004 to a centralized user configuration (CUC) node 1006 coupled to a central network controller (CNC), in accordance with some embodiments.

FIG. 10 shows an example of the capability exchange where the talker STA is associated with an AP. The AP requests the CUC for setting up a stream on behalf of the STA by including a wireless link information element whose link ID matches a virtual interface address (STA-x). The STA-x is selected such that the frame transmission rate of the (STA-1, AP) link closely matches that of the advertised (AP, STA-x) link. The Max end-to-end latency is also updated by setting the field as T′=T−(delay corresponding to (STA-x, AP) link)+(delay corresponding to (STA-1, AP) link).
(b) In one embodiment where the talker or listener STA is associated with a Mobile AP via a p2p link while the Mobile AP itself has a BSS link to the infrastructure AP, the infrastructure AP may account for the two hop link as follows:
(b.1) The AP may include a dummy or special MAC address or some other identifier corresponding to a “virtual interface” as the Link ID value in the Wireless Link Information element instead of the talker or listener MAC address. If multiple options are available, the AP picks as virtual talker/listener address the address for which the Wireless Link Dependent Delay information closely matches the actual two-hop transmission time of an octet of a frame from the talker STA to infra-AP via the Mobile AP.
(b.2) If a UserToNetworkRequirements group is included, the MaxLatency field is set, after accounting for the wireless link quality, as real MaxLatency for the end-to-end path−(latency for the (AP, virtual interface) link)+latency for the (Mobile AP, talker/listener) link+latency for (AP, STA collocated with Mobile AP) link.
(b.3) Once the CNC provides its Qbv schedule to the AP for the virtual interface, the AP configures the Qbv schedule for the (AP, Mobile AP) and (Mobile AP, talker) STA to align with that schedule.

FIG. 11 is a swimlane diagram of an abstracted capability exchange 1100 between a talker STA 1102 to the CUC 1110 where the STA 1102 is associated with a mobile AP while the device containing the mobile AP has an interface that is associated with an infrastructure AP, in accordance with some embodiments. FIG. 11 shows an example of the capability exchange where the talker STA is associated with a Mobile AP (AP-2) 1104 associated with STA-2 1106, while the device containing the Mobile AP is associated with an infrastructure AP (AP-1) 1108. AP-1 1108 requests the CUC 1110 on behalf of the STA by setting the Link ID field in the wireless link information element to a virtual interface address (STA-x). The STA-x is selected such that the effective frame transmission time of the (STA-1-to-AP-2 and STA-2-to-AP-1) path closely matches that derived from the advertised (AP, STA-x) link's Wireless Link Dependent delay parameter. The Max end-to-end latency is also updated by setting the field as T′=T−(delay corresponding to (STA-x, AP) link)+(delay corresponding to (STA-1, AP-2) link)+(delay corresponding to (STA-2, AP-1) link).

FIG. 12 illustrates example gate control list configurations 1200 which can be used by the infrastructure AP to configure the 802.11 Qbv schedule at each of its interfaces after receiving the CNC bridge configuration for the virtual interface for the example in FIG. 11, in accordance with some embodiments. More specifically, FIG. 12 illustrates an example of configuring a traffic class (EDCAF) queue for STAs in a BSS as a function of the configuration received for the virtual address at an AP. Note that the open times of the queues at the AP and Mobile AP are scheduled right next to each other so that the frame received at the Mobile AP can be delivered to infra-AP with low latency.

In one embodiment, an AP may also abstract information about its non-time-critical QoS traffic in its BSS by assigning it to a virtual interface represented by a Wireless Link Information element. The AP may aggregate multiple QoS streams (DL/UL/P2P) into one stream and request the CUC/CNC to create a schedule for it. Note that:
(a) The Max Latency bound of the aggregate stream could be the worst latency bound among the individual QoS streams; and
(b) The traffic Specification element sets its parameters such that the overall transmission time to deliver frames for this stream with the data transmission rate assumed for this interface (known from the corresponding Bridge Delay parameter) matches the overall transmission time for the aggregate traffic.

In some embodiments, an AP abstracts information about non-Timte-critical traffic in its BSS by providing an unavailability time window and including it in a newly managed object associated with this interface.

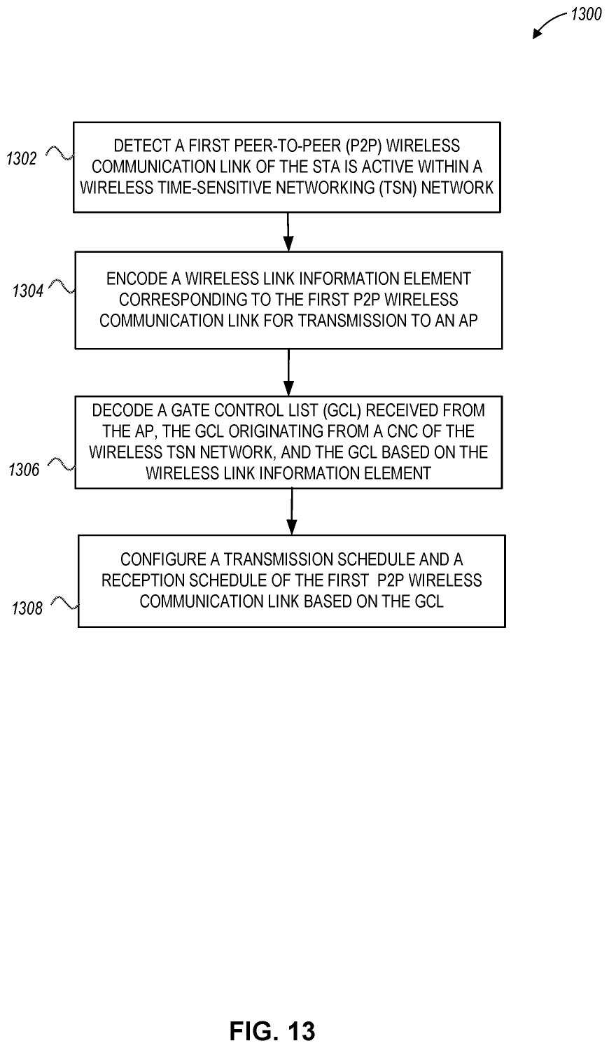

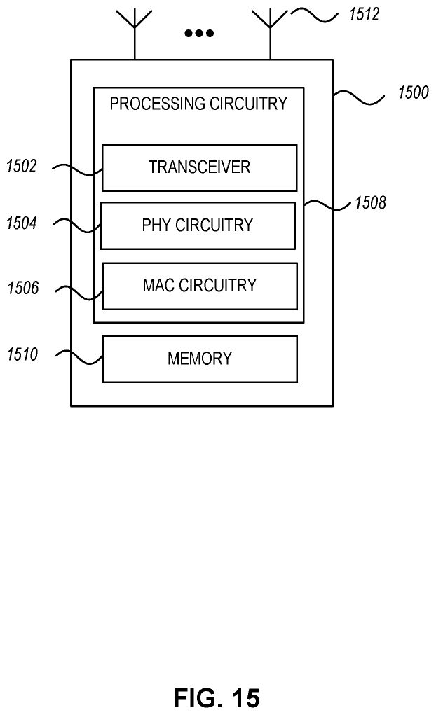

FIG. 13 is a flow diagram of an example method 1300 for enhancing wireless TSN configuration to support p2p communications, in accordance with some embodiments. Method 1300 includes operations 1302, 1304, 1306, and 1308, which can be performed by the wireless device 1500 of FIG. 15.

At operation 1302, the first peer-to-peer (p2p) wireless communication link of the STA is detected as active within a wireless time-sensitive networking (TSN) network.

At operation 1304, a wireless link information element corresponding to the first p2p wireless communication link is encoded for transmission to an access point (AP) of the wireless TSN network. The wireless link information element includes at least one attribute of the first p2p wireless communication link.

At operation 1306, a gate control list (GCL) received from the AP is decoded. The GCL originates from a central network controller (CNC) of the wireless TSN network. The GCL is based on the at least one attribute in the wireless link information element.

At operation 1308, a transmission schedule and a reception schedule of the first p2p wireless communication link are configured based on the GCL.

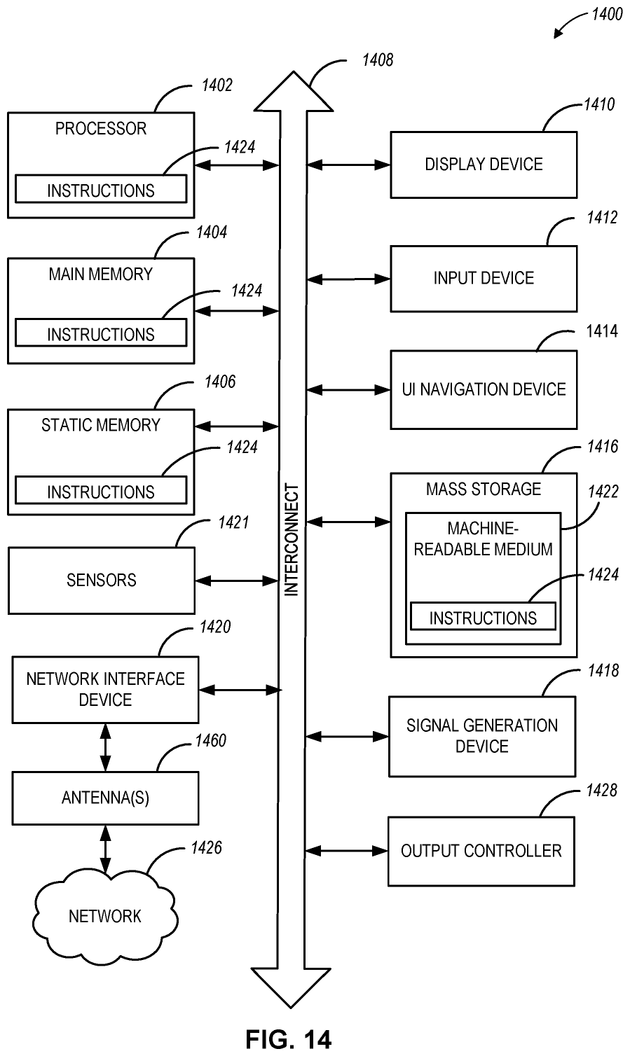

FIG. 14 illustrates a block diagram of an example machine 1400 upon which any one or more of the techniques (e.g., methodologies) discussed herein may perform. In alternative embodiments, the machine 1400 may operate as a standalone device or may be connected (e.g., networked) to other machines. In a networked deployment, machine 1400 may operate in the capacity of a server machine, a client machine, or both in server-client network environments. In an example, machine 1400 may act as a peer machine in a peer-to-peer (P2P) (or other distributed) network environment. The machine 1400 may be an AP 502, EHT station (STA) 504, personal computer (PC), a tablet PC, a set-top box (STB), a personal digital assistant (PDA), a portable communications device, a mobile telephone, a smartphone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 1400 may include a hardware processor 1402 (e.g., a central processing unit (CPU), a graphics processing unit (GPU), a hardware processor core, or any combination thereof), a main memory 1404, and a static memory 1406, some or all of which may communicate with each other via an interlink (e.g., bus) 1408.

Specific examples of main memory 1404 include Random Access Memory (RAM), and semiconductor memory devices, which may include, in some embodiments, storage locations in semiconductors such as registers. Specific examples of static memory 1406 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 1400 may further include a display device 1410, an input device 1412 (e.g., a keyboard), and a user interface (UI) navigation device 1414 (e.g., a mouse). In an example, the display device 1410, the input device 1412, and the UI navigation device 1414 may be a touch screen display. The machine 1400 may additionally include a storage device (e.g., drive unit) 1416, a signal generation device 1418 (e.g., a speaker), a network interface device 1420, and one or more sensors 1421, such as a global positioning system (GPS) sensor, compass, accelerometer, or other sensors. The machine 1400 may include an output controller 1428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments, the processor 1402 and/or instructions 1424 may comprise processing circuitry and/or transceiver circuitry.

The storage device 1416 may include a machine-readable medium 1422 on which is stored one or more sets of data structures or instructions 1424 (e.g., software) embodying or utilized by any one or more of the techniques or functions described herein. The instructions 1424 may also reside, completely or at least partially, within the main memory 1404, within static memory 1406, or the hardware processor 1402 during execution thereof by the machine 1400. In an example, one or any combination of the hardware processor 1402, the main memory 1404, the static memory 1406, or the storage device 1416 may constitute machine-readable media.

Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine-readable medium 1422 is illustrated as a single medium, the term “machine-readable medium” may include a single medium or multiple media (e.g., a centralized or distributed database, and/or associated caches and servers) configured to store instructions 1424.

An apparatus of the machine 1400 may be one or more of a hardware processor 1402 (e.g., a central processing unit (CPU), a graphics processing unit (GPU), a hardware processor core, or any combination thereof), a main memory 1404 and a static memory 1406, sensors 1421, the network interface device 1420, one or more antennas 1460, a display device 1410, an input device 1412, a UI navigation device 1414, a storage device 1416, instructions 1424, a signal generation device 1418, and an output controller 1428. The apparatus may be configured to perform one or more of the methods and/or operations disclosed herein. The apparatus may be intended as a component of machine 1400 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine-readable medium” may include any medium that is capable of storing, encoding, or carrying instructions for execution by machine 1400 and that causes the machine 1400 to perform any one or more of the techniques of the present disclosure, or that is capable of storing, encoding or carrying data structures used by or associated with such instructions. Non-limiting machine-readable medium examples may include solid-state memories and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine-readable media may include non-transitory machine-readable media. In some examples, machine-readable media may include machine-readable media that is not a transitory propagating signal.

The instructions 1424 may further be transmitted or received over a communications network 1426 using a transmission medium via the network interface device 1420 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 1420 may include one or more physical jacks (e.g., Ethernet, coaxial, or phone jacks) or one or more antennas to connect to the communications network 1426. In an example, the network interface device 1420 may include one or more antennas 1460 to wirelessly communicate using at least one of single-input multiple-output (SIMO), multiple-input multiple-output (MIMO), or multiple-input single-output (MISO) techniques. In some examples, the network interface device 1420 may wirelessly communicate using Multiple User MIMO techniques. The term “transmission medium” shall be taken to include any intangible medium that is capable of storing, encoding, or carrying instructions for execution by the machine 1400, and includes digital or analog communications signals or other intangible media to facilitate communication of such software.

Examples, as described herein, may include, or may operate on, logic or several components, modules, or mechanisms. Modules are tangible entities (e.g., hardware) capable of performing specified operations and may be configured or arranged in a certain manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; flash memory, etc.

FIG. 15 illustrates a block diagram of an example wireless device 1500 upon which any one or more of the techniques (e.g., methodologies or operations) discussed herein may perform. The wireless device 1500 may be a HE device or a HE wireless device. The wireless device 1500 may be an EHT STA 504, AP 502, and/or a HE STA or HE AP. An EHT STA 504, AP 502, and/or a HE AP or HE STA may include some or all of the components shown in FIGS. 1-15. The wireless device 1500 may be an example of machine 1400 as disclosed in conjunction with FIG. 12.

The wireless device 1500 may include processing circuitry 1508. The processing circuitry 1508 may include a transceiver 1502, physical layer circuitry (PHY circuitry) 1504, and MAC layer circuitry (MAC circuitry) 1506, one or more of which may enable transmission and reception of signals to and from other wireless devices (e.g., AP 502, EHT STA 504, and/or legacy devices 506) using one or more antennas 1512. As an example, the PHY circuitry 1504 may perform various encoding and decoding functions that may include the formation of baseband signals for transmission and decoding of received signals. As another example, the transceiver 1502 may perform various transmission and reception functions such as the conversion of signals between a baseband range and a Radio Frequency (RF) range.

Accordingly, the PHY circuitry 1504 and the transceiver 1502 may be separate components or may be part of a combined component, e.g., processing circuitry 1508. In addition, some of the described functionality related to the transmission and reception of signals may be performed by a combination that may include one, any, or all of the PHY circuitry 1504 the transceiver 1502, MAC circuitry 1506, memory 1510, and other components or layers. The MAC circuitry 1506 may control access to the wireless medium. The wireless device 1500 may also include memory 1510 arranged to perform the operations described herein, e.g., some of the operations described herein may be performed by instructions stored in memory 1510.

The one or more antennas 1512 (some embodiments may include only one antenna) may comprise one or more directional or omnidirectional antennas, including, for example, dipole antennas, monopole antennas, patch antennas, loop antennas, microstrip antennas, or other types of antennas suitable for transmission of RF signals. In some multiple-input multiple-output (MIMO) embodiments, the one or more antennas 1512 may be effectively separated to take advantage of spatial diversity and the different channel characteristics that may result.

One or more of the memory 1510, the transceiver 1502, the PHY circuitry 1504, the MAC circuitry 1506, the one or more antennas 1512, and/or the processing circuitry 1508 may be coupled with one another. Moreover, although memory 1510, the transceiver 1502, the PHY circuitry 1504, the MAC circuitry 1506, the one or more antennas 1512 are illustrated as separate components, one or more of memory 1510, the transceiver 1502, the PHY circuitry 1504, the MAC circuitry 1506, the one or more antennas 1512 may be integrated into an electronic package or chip.

In some embodiments, the wireless device 1500 may be a mobile device as described in conjunction with FIG. 14. In some embodiments, the wireless device 1500 may be configured to operate under one or more wireless communication standards as described herein. In some embodiments, the wireless device 1500 may include one or more of the components as described in conjunction with FIG. 14 (e.g., the display device 1410, input device 1412, etc.) Although the wireless device 1500 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application-specific integrated circuits (ASICs), radio-frequency integrated circuits (RFICs), and combinations of various hardware and logic circuitry for performing at least the functions described herein. In some embodiments, the functional elements may refer to one or more processes operating on one or more processing elements.

In some embodiments, an apparatus of or used by the wireless device 1500 may include various components of the wireless device 1500 as shown in FIG. 15 and/or components from FIGS. 1-15. Accordingly, techniques and operations described herein that refer to the wireless device 1500 may apply to an apparatus for a wireless device 1500 (e.g., AP 502 and/or EHT STA 504), in some embodiments. In some embodiments, the wireless device 1500 is configured to decode and/or encode signals, packets, and/or frames as described herein, e.g., PPDUs.

In some embodiments, the MAC circuitry 1506 may be arranged to contend for a wireless medium during a contention period to receive control of the medium for a HE TXOP and encode or decode an HE PPDU. In some embodiments, the MAC circuitry 1506 may be arranged to contend for the wireless medium based on channel contention settings, a transmitting power level, and a clear channel assessment level (e.g., energy detect level).

The PHY circuitry 1504 may be arranged to transmit signals following one or more communication standards described herein. For example, the PHY circuitry 1504 may be configured to transmit a HE PPDU. The PHY circuitry 1504 may include circuitry for modulation/demodulation, upconversion/downconversion, filtering, amplification, etc. In some embodiments, the processing circuitry 1508 may include one or more processors. The processing circuitry 1508 may be configured to perform functions based on instructions being stored in a RAM or ROM, or based on special-purpose circuitry. The processing circuitry 1508 may include a processor such as a general-purpose processor or a special-purpose processor. The processing circuitry 1508 may implement one or more functions associated with one or more antennas 1512, the transceiver 1502, the PHY circuitry 1504, the MAC circuitry 1506, and/or the memory 1510. In some embodiments, the processing circuitry 1508 may be configured to perform one or more of the functions/operations and/or methods described herein.

In mmWave technology, communication between a station (e.g., the EHT stations 504 of FIG. 5 or wireless device 1500) and an access point (e.g., the AP 502 of FIG. 5 or wireless device 1500) may use associated effective wireless channels that are highly directionally dependent. To accommodate the directionality, beamforming techniques may be utilized to radiate energy in a certain direction with a certain beam width to communicate between two devices. The directed propagation concentrates transmitted energy toward a target device to compensate for significant energy loss in the channel between the two communicating devices. Using directed transmission may extend the range of the millimeter-wave communication versus utilizing the same transmitted energy in omnidirectional propagation.

Examples, as described herein, may include, or may operate on, logic or several components, modules, or mechanisms. Modules are tangible entities (e.g., hardware) capable of performing specified operations and may be configured or arranged in a certain manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at different times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; flash memory, etc.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either concerning a particular example (or one or more aspects thereof) or concerning other examples (or one or more aspects thereof) shown or described herein.

Publications, patents, and patent documents referred to in this document are incorporated by reference herein in their entirety, as though individually incorporated by reference. In the event of inconsistent usage between this document and those documents so incorporated by reference, the usage in the incorporated reference(s) is supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in several environments such as part of a wireless local area network (WLAN), 3rd Generation Partnership Project (3GPP) Universal Terrestrial Radio Access Network (UTRAN), or Long-Term-Evolution (LTE) or a Long-Term-Evolution (LTE) communication system, although the scope of the disclosure is not limited in this respect.

Antennas referred to herein may comprise one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, antennas may be effectively separated to take advantage of spatial diversity and the different channel characteristics that may result between each antenna and the antennas of a transmitting station. In some MIMO embodiments, antennas may be separated by up to 1/10 of a wavelength or more.

Described implementations of the subject matter can include one or more features, alone or in combination as illustrated below by way of examples.

Example 1 is an apparatus of a station (STA), the apparatus comprising: memory; and processing circuitry coupled to the memory, the processing circuitry is to: detect a first peer-to-peer (p2p) wireless communication link of the STA is active within a wireless time-sensitive networking (TSN) network; encode a wireless link information element corresponding to the first p2p wireless communication link for transmission to an access point (AP) of the wireless TSN network, the wireless link information element comprising at least one attribute of the first p2p wireless communication link; decode a gate control list (GCL) received from the AP, the GCL originating from a central network controller (CNC) of the wireless TSN network, and the GCL based on the at least one attribute in the wireless link information element; and configure a transmission schedule and a reception schedule of the first p2p wireless communication link based on the GCL.

In Example 2, the subject matter of Example 1 includes subject matter where the processing circuitry is to: encode link identification (ID) information of first the p2p wireless communication link to generate the wireless link information element, the link ID information indicating a media access control (MAC) address of the first p2p wireless communication link.

In Example 3, the subject matter of Example 2 includes subject matter where the processing circuitry is to: encode link mode information of the first p2p wireless communication link to generate the wireless link information element, the link mode information indicating one of a basic service set (BSS) link mode and a p2p link mode for the first p2p wireless communication link.

In Example 4, the subject matter of Example 3 includes subject matter where the processing circuitry is to: encode channel number information of the first p2p wireless communication link to generate the wireless link information element.

In Example 5, the subject matter of Examples 1˜4 includes subject matter where the processing circuitry is to: encode minimum and maximum independent delay information of the first p2p wireless communication link to generate the wireless link information element.

In Example 6, the subject matter of Example 5 includes subject matter where the processing circuitry is to: encode a wireless link independent delay descriptor of the first p2p wireless communication link to generate the wireless link information element, the wireless link independent delay descriptor indicating a delay update interval, a delay standard deviation, and mean delay information associated with the first p2p wireless communication link.

In Example 7, the subject matter of Examples 1-6 includes subject matter where the processing circuitry is to: detect a second p2p wireless communication link of the STA is active within the wireless TSN network; and encode the wireless link information element to include a link operation constraints list associated with the first p2p wireless communication link and the second p2p wireless communication link.

In Example 8, the subject matter of Example 7 includes, the link operation constraints list indicates the first p2p wireless communication link and the second p2p wireless communication link can operate simultaneously.

In Example 9, the subject matter of Examples 7-8 includes, the link operation constraints list indicates the first p2p wireless communication link and the second p2p wireless communication link cannot operate simultaneously.

Example 10 is an apparatus of an access point (AP) in wireless time-sensitive networking (TSN) network, the apparatus comprising: memory; and processing circuitry coupled to the memory, the processing circuitry is to: decode a wireless link information element received from a station (STA) of the wireless TSN network, the wireless link information element corresponding to a peer-to-peer (p2p) wireless communication link of the STA that is active within the wireless TSN network, and the wireless link information element comprising at least one attribute of the p2p wireless communication link; encode the wireless link information element for transmission to a centralized user configuration (CUC) node of the wireless TSN network; decode a gate control list (GCL) received from a central network controller (CNC) associated with the CUC node, the GCL based on the at least one attribute in the wireless link information element; encode the GCL for transmission to the AP; and perform transmission or reception of data from the STA according to a transmission schedule and a reception schedule based on the GCL.

In Example 11, the subject matter of Example 10 includes subject matter where the wireless link information element includes at least one of link identification (ID) information of the p2p wireless communication link, the link ID information indicating a media access control (MAC) address of the p2p wireless communication link; link mode information of the p2p wireless communication link, the link mode information indicating one of a basic service set (BSS) link mode and a p2p link mode for the p2p wireless communication link; and channel number information of the p2p wireless communication link.

In Example 12, the subject matter of Examples 10-11 includes subject matter where the wireless link information element includes at least one of minimum and maximum independent delay information of the p2p wireless communication link to generate the wireless link information element; and a wireless link independent delay descriptor of the p2p wireless communication link, the wireless link independent delay descriptor indicating a delay update interval, a delay standard deviation, and mean delay information associated with the p2p wireless communication link.

Example 13 is a non-transitory computer-readable storage medium that stores instructions for execution by one or more processors of an apparatus of a station (STA), the instructions to cause the one or more processors to: detect a first peer-to-peer (p2p) wireless communication link of the STA is active within a wireless time-sensitive networking (TSN) network; encode a wireless link information element corresponding to the first p2p wireless communication link for transmission to an access point (AP) of the wireless TSN network, the wireless link information element comprising at least one attribute of the first p2p wireless communication link; decode a gate control list (GCL) received from the AP, the GCL originating from a central network controller (CNC) of the wireless TSN network, and the GCL based on the at least one attribute in the wireless link information element; and configure a transmission schedule and a reception schedule of the first p2p wireless communication link based on the GCL.

In Example 14, the subject matter of Example 13 includes subject matter where the instructions further cause the one or more processors to encode link identification (ID) information of first the p2p wireless communication link to generate the wireless link information element, the link ID information indicating a media access control (MAC) address of the first p2p wireless communication link.

In Example 15, the subject matter of Example 14 includes subject matter where the instructions further cause the one or more processors to encode link mode information of the first p2p wireless communication link to generate the wireless link information element, the link mode information indicating one of a basic service set (BSS) link mode and a p2p link mode for the first p2p wireless communication link.

In Example 16, the subject matter of Example 15 includes subject matter where the instructions further cause the one or more processors to encode channel number information of the first p2p wireless communication link to generate the wireless link information element.

In Example 17, the subject matter of Examples 13-16 includes subject matter where the instructions further cause the one or more processors to encode minimum and maximum independent delay information of the first p2p wireless communication link to generate the wireless link information element.

In Example 18, the subject matter of Example 17 includes subject matter where the instructions further cause the one or more processors to encode a wireless link independent delay descriptor of the first p2p wireless communication link to generate the wireless link information element, the wireless link independent delay descriptor indicating a delay update interval, a delay standard deviation, and mean delay information associated with the first p2p wireless communication link.

In Example 19, the subject matter of Examples 13-18 includes subject matter where the instructions further cause the one or more processors to: detect a second p2p wireless communication link of the STA is active within the wireless TSN network; and encode the wireless link information element to include a link operation constraints list associated with the first p2p wireless communication link and the second p2p wireless communication link.

In Example 20, the subject matter of Example 19 includes subject matter where the link operation constraints list indicates one of the first p2p wireless communication link and the second p2p wireless communication link can operate simultaneously; or the first p2p wireless communication link and the second p2p wireless communication link cannot operate simultaneously.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined regarding the appended claims, along with the full scope of equivalents to which such claims are entitled.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a station (STA), the apparatus comprising:
memory; and
processing circuitry coupled to the memory, the processing circuitry is to:
detect a first peer-to-peer (p2p) wireless communication link of the STA is active within a wireless time-sensitive networking (TSN) network;
encode a wireless link information element corresponding to the first p2p wireless communication link for transmission to an access point (AP) of the wireless TSN network, the wireless link information element comprising at least one attribute of the first p2p wireless communication link;
decode a gate control list (GCL) received from the AP, the GCL originating from a central network controller (CNC) of the wireless TSN network, and the GCL based on the at least one attribute in the wireless link information element; and
configure a transmission schedule and a reception schedule of the first p2p wireless communication link based on the GCL.

2. The apparatus of claim 1, wherein the processing circuitry is to:
encode link identification (ID) information of first the p2p wireless communication link to generate the wireless link information element, the link ID information indicating a media access control (MAC) address of the first p2p wireless communication link.

3. The apparatus of claim 2, wherein the processing circuitry is to:
encode link mode information of the first p2p wireless communication link to generate the wireless link information element, the link mode information indicating one of a basic service set (BSS) link mode and a p2p link mode for the first p2p wireless communication link.

4. The apparatus of claim 3, wherein the processing circuitry is to:
encode channel number information of the first p2p wireless communication link to generate the wireless link information element.

5. The apparatus of claim 1, wherein the processing circuitry is to:
encode minimum and maximum independent delay information of the first p2p wireless communication link to generate the wireless link information element.

6. The apparatus of claim 5, wherein the processing circuitry is to:
encode a wireless link independent delay descriptor of the first p2p wireless communication link to generate the wireless link information element, the wireless link independent delay descriptor indicating a delay update interval, a delay standard deviation, and mean delay information associated with the first p2p wireless communication link.

7. The apparatus of claim 1, wherein the processing circuitry is to:
detect a second p2p wireless communication link of the STA is active within the wireless TSN network; and
encode the wireless link information element to include a link operation constraints list associated with the first p2p wireless communication link and the second p2p wireless communication link.

8. The apparatus of claim 7, wherein the link operation constraints list indicates the first p2p wireless communication link and the second p2p wireless communication link can operate simultaneously.

9. The apparatus of claim 7, wherein the link operation constraints list indicates the first p2p wireless communication link and the second p2p wireless communication link cannot operate simultaneously.

10. An apparatus of an access point (AP) in wireless time-sensitive networking (TSN) network, the apparatus comprising:
memory; and
processing circuitry coupled to the memory, the processing circuitry is to:
decode a wireless link information element received from a station (STA) of the wireless TSN network, the wireless link information element corresponding to a peer-to-peer (p2p) wireless communication link of the STA that is active within the wireless TSN network, and the wireless link information element comprising at least one attribute of the p2p wireless communication link;
encode the wireless link information element for transmission to a centralized user configuration (CUC) node of the wireless TSN network;
decode a gate control list (GCL) received from a central network controller (CNC) associated with the CUC node, the GCL based on the at least one attribute in the wireless link information element;
encode the GCL for transmission to the AP; and
perform transmission or reception of data from the STA according to a transmission schedule and a reception schedule based on the GCL.

11. The apparatus of claim 10, wherein the wireless link information element includes at least one of:
link identification (ID) information of the p2p wireless communication link, the link ID information indicating a media access control (MAC) address of the p2p wireless communication link;
link mode information of the p2p wireless communication link, the link mode information indicating one of a basic service set (BSS) link mode and a p2p link mode for the p2p wireless communication link; and
channel number information of the p2p wireless communication link.

12. The apparatus of claim 10, wherein the wireless link information element includes at least one of:
minimum and maximum independent delay information of the p2p wireless communication link to generate the wireless link information element; and
a wireless link independent delay descriptor of the p2p wireless communication link, the wireless link independent delay descriptor indicating a delay update interval, a delay standard deviation, and mean delay information associated with the p2p wireless communication link.

13. A non-transitory computer-readable storage medium that stores instructions for execution by one or more processors of an apparatus of a station (STA), the instructions to cause the one or more processors to:
detect a first peer-to-peer (p2p) wireless communication link of the STA is active within a wireless time-sensitive networking (TSN) network;
encode a wireless link information element corresponding to the first p2p wireless communication link for transmission to an access point (AP) of the wireless TSN network, the wireless link information element comprising at least one attribute of the first p2p wireless communication link;
decode a gate control list (GCL) received from the AP, the GCL originating from a central network controller (CNC) of the wireless TSN network, and the GCL based on the at least one attribute in the wireless link information element; and
configure a transmission schedule and a reception schedule of the first p2p wireless communication link based on the GCL.

14. The non-transitory computer-readable storage medium of claim 13, wherein the instructions further cause the one or more processors to:
encode link identification (ID) information of first the p2p wireless communication link to generate the wireless link information element, the link ID information indicating a media access control (MAC) address of the first p2p wireless communication link.

15. The non-transitory computer-readable storage medium of claim 14, wherein the instructions further cause the one or more processors to:
encode link mode information of the first p2p wireless communication link to generate the wireless link information element, the link mode information indicating one of a basic service set (BSS) link mode and a p2p link mode for the first p2p wireless communication link.

16. The non-transitory computer-readable storage medium of claim 15, wherein the instructions further cause the one or more processors to:
encode channel number information of the first p2p wireless communication link to generate the wireless link information element.

17. The non-transitory computer-readable storage medium of claim 13, wherein the instructions further cause the one or more processors to:
encode minimum and maximum independent delay information of the first p2p wireless communication link to generate the wireless link information element.

18. The non-transitory computer-readable storage medium of claim 17, wherein the instructions further cause the one or more processors to:
encode a wireless link independent delay descriptor of the first p2p wireless communication link to generate the wireless link information element, the wireless link independent delay descriptor indicating a delay update interval, a delay standard deviation, and mean delay information associated with the first p2p wireless communication link.

19. The non-transitory computer-readable storage medium of claim 13, wherein the instructions further cause the one or more processors to:
detect a second p2p wireless communication link of the STA is active within the wireless TSN network; and
encode the wireless link information element to include a link operation constraints list associated with the first p2p wireless communication link and the second p2p wireless communication link.

20. The non-transitory computer-readable storage medium of claim 19, wherein the link operation constraints list indicates one of:
the first p2p wireless communication link and the second p2p wireless communication link can operate simultaneously; or
the first p2p wireless communication link and the second p2p wireless communication link cannot operate simultaneously.
